(19) United States
(12) Patent Application Publication
(10) Pub. No.: US 2024/0212664 A1
(43) Pub. Date: Jun. 27, 2024

(54) VIRTUAL ENGINE SOUND GENERATING SYSTEM AND METHOD USING ENGINE VIBRATION SIMULATED SIGNAL

(71) Applicant: HYUNDAI MOBIS CO., LTD., Seoul (KR)

(72) Inventor: Jae Young LEE, Icheon-si (KR)

(73) Assignee: HYUNDAI MOBIS CO., LTD., Seoul (KR)

(21) Appl. No.: 18/495,461

(22) Filed: Oct. 26, 2023

(30) Foreign Application Priority Data
Dec. 27, 2022 (KR) 10-2022-0185175

(51) Int. Cl. G10K 15/02; B60Q 9/00; G05B 13/02

(52) U.S. Cl. CPC G10K 15/02; B60Q 9/00; G05B 13/027

(57) ABSTRACT

Systems and methods for generating an engine vibration simulated signal, which is an acceleration sensor simulated signal, generate the signal based on current driving-related information, without mounting an acceleration sensor on an engine, such that a virtual engine sound can be controlled to be output naturally according to an engine output torque of a vehicle.

### CROSS-REFERENCE TO RELATED APPLICATIONS

This application claims priority under 35 U.S.C. §119 to Korean Patent Application No. 10-2022-0185175, filed on Dec. 27, 2022, in the Korean Intellectual Property Office, the disclosure of which is incorporated herein by reference in its entirety.

### TECHNICAL FIELD

The following disclosure relates to a virtual engine sound generating system and method using an engine vibration simulated signal, and more particularly, to a virtual engine sound generating system and method using an engine vibration simulated signal capable of generating an engine vibration simulated signal suitable for a driving situation of a vehicle to generate a virtual engine sound that can be changed to be natural according to an engine output torque.

### BACKGROUND

An active sound design (ASD) system outputs a richer and more dynamic engine sound than an existing engine sound by adding a new sound to the existing engine sound using an acoustic effect enhancing technique to change or improve a sound inside and outside the vehicle.

Recently, as the demand for eco-friendly engines has increased, the efficiency of engine systems has increased, but vehicles with such eco-friendly engines generate a high-pitch sound that general combustion engines do not have, resulting in low auditory satisfaction in vehicle occupants.

In order to give emotional satisfaction to the vehicle occupants in terms of a driving quality regarding an acoustic effect of the engine, an ASD system is applied to generate and output a virtual engine sound (synthesized engine sound) through speakers inside and outside the vehicle.

However, the ASD system has a problem in that vibration characteristics are not reflected according to engine conditions. In order to overcome this problem, an engine sound by engine vibration (ESEV) system has been proposed.

When the ASD system generates a virtual engine sound, the ESEV system changes an output size of the virtual engine sound by using a value sensed by an acceleration sensor mounted on the engine.

This is advantageous in that a change in output size of the virtual engine sound can be provided naturally depending on an engine output torque even though the RPM remains unchanged.

The output size of the virtual engine sound generated through the ASD system can be changed by reflecting a natural vibration coefficient of the engine mounted in the vehicle, which can be inferred through a value sensed by the acceleration sensor. This is advantageous in that vehicle occupants feel more absorbed in driving as well as giving pleasure to the vehicle occupants during driving.

Since the ESEV system requires an acceleration sensor to be mounted on the engine in order to detect vibration of the engine as described above, the costs for the acceleration sensor and the wiring are inevitably incurred in addition to the costs for the ASD system.

In addition, as functions of vehicles have recently improved, the number of sensors installed in the vehicles has increased, and accordingly, the number of wires for connecting the sensors to a controller (control system) and the lengths of the wires have naturally increased.

The increases in the number of wires and the lengths of the wires naturally make vehicle maintenance work difficult, and changes in design are inevitably restrictive due to the increase in volume of the wires. In addition, the weight of the vehicle also increases, which is another cause of reduction in fuel efficiency.

In addition, since the acceleration sensor of the ESEV system is located in an engine room where vibration and temperature conditions are poor, additional costs are incurred to enhance conditions for reliability, and the ESEV system is inevitably vulnerable to electrical noise. Accordingly, even if a cable shield is used, noise introduced from the acceleration sensor may directly flow into a speaker inside or outside the vehicle, making it very difficult to configure the system.

### SUMMARY

An embodiment of the present invention is directed to providing a virtual engine sound generating system and method using an engine vibration simulated signal capable of providing a virtual engine sound of which an output is controlled according to a current engine vibration situation based on a virtual engine vibration simulated signal generated when a current driving condition of a vehicle in a driving state is input.

In one general aspect, a virtual engine sound generating system using an engine vibration simulated signal for a vehicle to which an active sound design (ASD) function and an engine sound by engine vibration (ESEV) function are applied includes: an information input unit receiving driving-related information from the vehicle in a driving state and a random number generated randomly through a random number generator; a signal generation unit to which a vibration simulated signal for an engine of the vehicle in the driving state is output, when the information input unit inputs the driving-related information and the random number to a stored generation model; and an output control unit controlling an output state of a virtual engine sound output to the vehicle in the driving state through the ADS function, when the signal generation unit inputs the vibration simulated signal to a control system having the ESEV function.

The driving-related information input to the information input unit may include at least one of vehicle speed information, engine RPM information, and accelerator pedal sensor (APS) sensing information of the vehicle in the driving state.

The output control unit may control an output size of the virtual engine sound output to be suitable for an engine vibration situation of the vehicle in the driving state according to the vibration simulated signal.

The virtual engine sound generating system may further include a model generation unit generating a generation model that outputs a virtual vibration simulated signal using vehicle speed information, engine RPM information, APS sensing information, and the random number input thereto, while applying conditional GAN (cGAN) algorithm.

The model generation unit may include: a data collection unit receiving driving-related information in a driving state from a data acquisition vehicle, to which the ADS function and the ESEV function are applied with an acceleration sensor mounted an engine thereof, and a vibration signal from the acceleration sensor to be collected in a database; a generation unit implemented as a convolutional neural network and having a decoder structure, the generation unit generating a vibration simulated signal corresponding to the data acquisition vehicle when receiving the driving-related information from the data collection unit together with a random number generated randomly through a random number generator; a classification unit implemented as a convolutional neural network and having a classification network structure, the classification unit outputting a result of classifying the vibration signal, which is a real signal, and the vibration simulated signal, which is a simulated signal, when receiving the driving-related information and the vibration signal from the data collection unit and the vibration simulated signal from the generation unit; and a learning processing unit learning an operation of the generation unit for generating vibration simulated signals in such a manner as to minimize a classification accuracy, and learning a classification operation in such a manner that the classification unit increases a classification accuracy against the generation unit in an adversarial way, assuming that the classification unit perfectly classifies signals into real signals and simulated signals by applying cGAN algorithm.

The learning processing unit may control the generation unit and the classification unit to perform adversarial iterative learning in such a manner that the generation unit is trained after the classification unit is trained.

The signal generation unit may apply a learning model according to a learning result of the generation unit as the generation model.

In another general aspect, a virtual engine sound generating method using an engine vibration simulated signal using a virtual engine sound generating system using an engine vibration simulated signal for a vehicle to which an active sound design (ASD) function and an engine sound by engine vibration (ESEV) function are applied includes the following steps, each being performed by an arithmetic processing means: an information input step (S100) in which driving-related information from the vehicle in a driving state and a random number generated randomly through a random number generator are input; a signal generation step (S200) in which a vibration simulated signal for an engine of the vehicle in the driving state is output, when the driving-related information and the random number input in the information input step (S100) are input, using a stored generation model; and an output control step (S300) in which an output state of a virtual engine sound output to the vehicle in the driving state through the ADS function is controlled, when the vibration simulated signal generated in the signal generation step (S200) is input to a control system having the ESEV function.

In the information input step (S100), the driving-related information may include at least one of vehicle speed information, engine RPM information, and accelerator pedal sensor (APS) sensing information of the vehicle in the driving state.

In the output control step (S300), an output size of the virtual engine sound output to the vehicle in the driving state through the ADS function may be controlled to be suitable for an engine vibration situation of the vehicle in the driving state using the vibration simulated signal.

The virtual engine sound generating method may further include a model generation step (S10) in which the generation model that outputs a virtual vibration simulated signal is generated using vehicle speed information, engine RPM information, APS sensing information, and the random number input thereto, while applying conditional GAN (cGAN) algorithm, to store the generation model before the signal generation step (S200) is performed.

The model generation step (S10) may include: a data collection step (S11) in which driving-related information in a driving state from a data acquisition vehicle, to which the ADS function and the ESEV function are applied with an acceleration sensor mounted an engine thereof, and a vibration signal from the acceleration sensor are input; a generation step (S12) in which a generation unit implemented as a convolutional neural network and having a decoder structure generates a vibration simulated signal corresponding to the data acquisition vehicle when receiving the driving-related information input in the data collection step (S11) together with a random number generated randomly through a random number generator; a classification step (S13) in which a classification unit implemented as a convolutional neural network and having a classification network structure outputs a result of classifying the vibration signal, which is a real signal, and the vibration simulated signal, which is a simulated signal, when receiving the driving-related information and the vibration signal input in the data collection step (S11) and the vibration simulated signal generated in the generation step (S12); and a learning processing step (S14) in which an operation of the generation unit for generating vibration simulated signals is learned in such a manner as to minimize a classification accuracy, and a classification operation is learned in such a manner that the classification unit increases a classification accuracy against the generation unit in an adversarial way, assuming that the classification unit perfectly classifies signals into real signals and simulated signals by applying cGAN algorithm, and in the learning processing step (S14), the generation unit and the classification unit may be controlled to perform adversarial iterative learning in such a manner that the generation unit is trained after the classification unit is trained.

In the signal generation step (S200), a learning model according to a learning result of the generation unit may be applied as the generation model.

The virtual engine sound generating system and method using an engine vibration simulated signal according to the present invention as described above are advantageous in that the ESEV function can be provided without requiring an acceleration sensor mounted in the engine room, thereby reducing the costs because no acceleration sensor is required in the engine room while providing the ESEV function.

In particular, the virtual engine sound generating system and method using an engine vibration simulated signal according to the present invention as described above are advantageous in that it is possible to reduce the number of acceleration sensors, the weights of wires, and the space required for the acceleration sensors and the wires, thereby improving fuel efficiency and improving a degree of freedom in designing the engine room.

In addition, the virtual engine sound generating system and method using an engine vibration simulated signal according to the present invention as described above are advantageous in that it is possible to prevent inflow of noise such as vibration, high temperature, and electromagnetic waves generated in the engine room, thereby implementing an audio system capable of outputting a virtual engine sound that is robust against noise.

### BRIEF DESCRIPTION OF THE DRAWINGS

FIG. 1 is a block diagram illustrating a virtual engine sound generating system using an engine vibration simulated signal according to an embodiment of the present invention.

FIG. 2 is a flowchart illustrating a virtual engine sound generating method using an engine vibration simulated signal according to an embodiment of the present invention.

### DETAILED DESCRIPTION

The aforementioned objects, features, and advantages of the present invention will be more apparent from the embodiments to be described below with reference to the accompanying drawings. The following specific structural or functional descriptions are provided merely for the purpose of describing embodiments according to the concept of the present invention, and the embodiments according to the concept of the present invention can be implemented in various forms and should not be construed as being limited to the embodiments set forth herein. Since various modifications may be made to the embodiments according to the concept of the present invention, and the embodiments of the present invention may have various forms, specific embodiments will be illustrated in the drawings and described in detail hereinbelow. However, this is not intended to limit the embodiments according to the concept of the present invention to specific forms disclosed herein, and it should be noted that the specific embodiments described herein cover all modifications, equivalents, or substitutes within the spirit and technical scope of the present invention. Terms “first”, “second”, and/or the like may be used to describe various components (???), but the components are not limited by the above terms. The above terms are only used to distinguish one component from another component. For example, a first component may be referred to as a second component, and similarly, a second component may be referred to as a first component, without departing from the scope according to the concept of the present disclosure. It should be noted that, when one component is referred to as being coupled or connected to another component, the one component may be directly coupled or connected to the another component, or the one component may be coupled or connected to the another component through an intervening component therebetween. On the other hand, when one component is referred to as being directly coupled to or directly connected to another component, there is no intervening component therebetween. Other expressions for describing relationships between components, that is, expressions such as “between”, “immediately between”, “adjacent to”, and “directly adjacent to” shall be construed similarly. Terms used herein are used only to describe the specific embodiments and are not intended to limit the present invention. Singular expressions include plural expressions unless the context clearly indicates otherwise. It should be noted that terms “include”, “have”, and the like used herein are intended to specify the presence of stated features, numbers, steps, operations, components, parts, or combinations thereof but do not preclude the presence or addition of one or more other features, numbers, steps, operations, components, parts, or combinations thereof. Unless otherwise defined, all terms used herein, including technical or scientific terms, have the same meanings as those generally understood by those skilled in the art to which the present invention pertains. The terms defined in generally used dictionaries and the like should be interpreted as having the same meanings as those in the context of the related art and should not be interpreted as having ideal or excessively formal meanings unless clearly defined herein. Hereinafter, the present invention will be described in detail by describing preferred embodiments of the present invention with reference to the accompanying drawings. Like reference signs in the drawings indicate like elements.

In addition, a system refers to a set of components including devices, mechanisms, means, and the like that are organized to regularly interact with each other in order to perform necessary functions.

An engine sound by engine vibration (ESEV) function (ESEV system) currently installed in a vehicle requires an acceleration sensor to be mounted on an engine to sense a magnitude of engine vibration, such that an acoustic effect of a virtual engine sound (synthesized engine sound) generated through an active sound design (ASD) system is adjusted by reflecting a natural vibration coefficient of the engine to the virtual engine sound through a sensed value.

As described above, the acceleration sensor is mounted in the engine room. The additional installation of the acceleration sensor not only increases costs but also causes noise due to the temperature, vibration, and electromagnetic waves of the engine room, and the noise may be introduced into a sound output to the inside or outside of the vehicle.

In view of the above, a virtual engine sound generating system and method using an engine vibration simulated signal according to an embodiment of the present invention relate to a technology capable of providing an ESEV function without an acceleration sensor.

By eliminating the need for an acceleration sensor, the virtual engine sound generating system and method using an engine vibration simulated signal according to an embodiment of the present invention not only reduces costs but also does not generate noise that may occur from an acceleration sensor. Therefore, the virtual engine sound generating system and method using an engine vibration simulated signal according to an embodiment of the present invention is advantageous in that a virtual engine sound (synthesized engine sound) output to the inside or outside of a vehicle has improved robustness against noise.

To briefly explain the virtual engine sound generating system and method using an engine vibration simulated signal according to an embodiment of the present invention based thereon, an engine vibration simulated signal suitable for a current driving condition of the vehicle is generated using conditional GAN (cGAN) algorithm, and an acoustic effect of a virtual engine sound generated through an ASD system is adjusted by reflecting the engine vibration simulated signal to the virtual engine sound. That is, the virtual engine sound generating system and method using an engine vibration simulated signal according to an embodiment of the present invention is capable of providing an ESEV function without an acceleration sensor, resulting in a minimal increase in cost while adding the ESEV function to the vehicle. Therefore, the costs can be efficiently reduced.

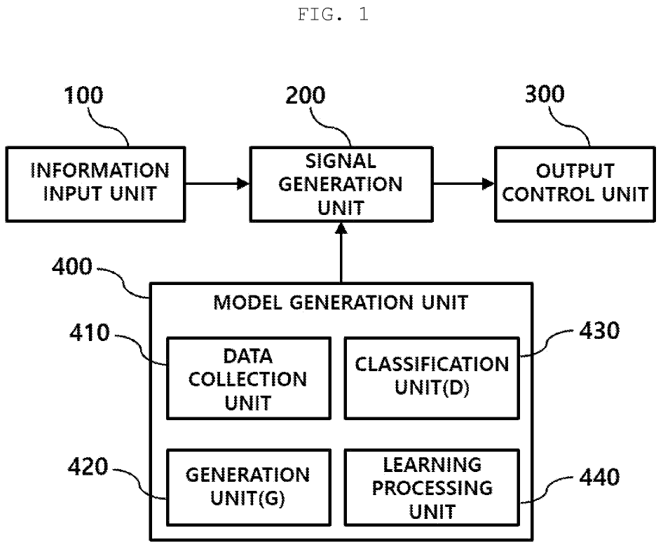

FIG. 1 is a block diagram of a virtual engine sound generating system using an engine vibration simulated signal according to an embodiment of the present invention.

As illustrated in FIG. 1, the virtual engine sound generating system using an engine vibration simulated signal according to an embodiment of the present invention may include an information input unit 100, a signal generation unit 200, and an output control unit 300. It is preferable that each of the components performs an operation through an arithmetic processing means such as an electronic control unit (ECU) including a computer that performs transmission and reception through an in-vehicle communication channel.

In addition, the virtual engine sound generating system using an engine vibration simulated signal according to an embodiment of the present invention is a virtual engine sound generating system for a vehicle to which an active sound design (ASD) function and an engine sound by engine vibration (ESEV) function are applied. Specifically, the virtual engine sound generating system using an engine vibration simulated signal according to an embodiment of the present invention outputs a virtual engine sound (synthesized engine sound) generated through the ASD function after controlling a size of the virtual engine sound to be suitable for a vibration situation of the engine based on the ESEV function.

At this point, the conventional ESEV function requires a value sensed by an acceleration sensor mounted on the engine and provided in the engine room, whereas the virtual engine sound generating system using an engine vibration simulated signal according to an embodiment of the present invention is advantageous in that the ESEV function can be provided (the acoustic effect of the virtual engine sound can be adjusted) without an acceleration sensor.

Each of the components will be described in detail below.

Preferably, the information input unit 100 receives driving-related information from the vehicle in a driving state and a random number generated randomly through a random number generator stored in an in-vehicle control system.

Here, the vehicle in the driving state is a vehicle to which the ASD function and the ESEV function are applied, with no acceleration sensor provided in the engine room.

In addition, the driving-related information includes at least one of vehicle speed information, engine RPM information, and information currently sensed by an accelerator pedal sensor (APS).

Such driving-related information is received using an in-vehicle communication channel (CAN communication or the like).

When the information input unit 100 inputs the driving-related information (vehicle speed information, engine RPM information, and APS sensing information) and random number to a stored generation model, a vibration simulated signal for the engine of the vehicle in the driving state is output to the signal generation unit 200.

That is, a virtual vibration signal in which the engine vibration situation of the vehicle in the driving state is reflected is output.

To this end, the virtual engine sound generating system using an engine vibration simulated signal according to an embodiment of the present invention further includes a model generation unit 400, as illustrated in FIG. 1, to generate a generation model to be used by the signal generation unit 200.

The model generation unit 400 generates a generation model that outputs a virtual vibration simulated signal by analyzing the vehicle speed information, engine RPM information, APS sensing information, and random number input thereto, while applying conditional GAN (cGAN) algorithm.

The cGAN algorithm is a generative adversarial network in which a generator and a discriminator are conditioned using additional information while being trained. By using the cGAN algorithm, data containing desired classes can be generated, and labeled data can be used in training both the generator and the discriminator.

As illustrated in FIG. 1, the model generation unit 400 preferably includes a data collection unit 410, a generation unit 420, a classification unit 430, and a learning processing unit 440.

The data collection unit 410 is a component for generating a training data set to be input to the cGAN algorithm, and receives vehicle speed information, engine RPM information, and APS sensing information acquired from a data acquisition vehicle in a driving state. At this time, similarly to the information input unit 100, the data collection unit 410 receives the information using an in-vehicle communication channel.

In addition, the data collection unit 410 receives an engine vibration signal, which is a sensed signal, from an acceleration sensor mounted on an engine of the data acquisition vehicle.

Therefore, the data acquisition vehicle is a vehicle to which the ASD function and the ESEV function are applied, with an acceleration sensor provided in an engine room thereof.

The data collection unit 410 generates the received vehicle speed information, engine RPM information, and APS sensing information of the vehicle in the driving state together with the engine vibration signal as a training data set for training an artificial intelligence network, while being stored and managed in a database.

The generation unit 420, which is a generator implemented as a convolutional neural network and having a decoder structure, generates a vibration simulated signal corresponding to the data acquisition vehicle when receiving the driving-related information (vehicle speed information, engine RPM information, and APS sensing information) from the data collection unit 410 together with a random number generated randomly through a random number generator.

That is, the generator of the cGAN algorithm receives random vectors (random noise) and labeled data, and outputs fake samples generated to match the given labels as much as possible. The purpose of the generator is to generate fake samples that match the given labels and are similar to real ones so that the discriminator cannot discriminate the fake samples.

Taking this into consideration, the generation unit 420 performs learning to generate signals similar to real ones so that the classification unit 430 cannot distinguish the signals.

The classification unit 430, which is a discriminator implemented as a convolutional neural network and having a classification network structure, outputs a result of classifying the vibration signal, which is a real signal, and the vibration simulated signal, which is a simulated signal, when receiving the driving-related information (vehicle speed information, engine RPM information, and APS sensing information) and the engine vibration signal from the data collection unit 410 and the vibration simulated signal generated by the generation unit 420.

That is, the discriminator of the cGAN algorithm receives the data from the training data set and the fake samples generated by the generator, and outputs a probability as to which samples are real and which samples are fake. The purpose of the discriminator is to distinguish between fake sample-label pairs generated by the generator and genuine sample-label pairs from the training data set.

Taking this into consideration, the classification unit 430 performs learning to distinguish between real signals from the acceleration sensor and virtual simulated signals.

Assuming that the classification unit 430 perfectly classifies signals into real signals and simulated signals by applying cGAN algorithm, the learning processing unit 440 learns an operation of the generation unit 420 for generating vibration simulated signals in such a manner as to minimize a classification accuracy, and learns a classification operation in such a manner that the classification unit 430 increases a classification accuracy against the generation unit 420 in an adversarial way.

Specifically, the learning processing unit 440 processes the generation unit 420 and the classification unit 430 to perform adversarial iterative learning, but it is preferable to perform control so that the generation unit 420 is trained after the classification unit 430 is trained.

To specifically describe the learning process, first of all, a vibration simulated signal is generated when driving-related information (driving condition) and a random number are input to the generation unit 420 (G) from the data collection unit 410.

The classification unit 430 (D) performs a classification operation, when the driving-related information and the engine vibration signal from the data collection unit 410 are input to the classification unit 430 together with the vibration simulated signal generated by the generation unit 420. By performing the classification operation, it is distinguished which signal is a real signal acquired through the acceleration sensor and which signal is a generated vibration simulated signal.

The classification unit 430 performs learning processing in a direction toward reducing a loss using the classification result. That is, in order to improve the classification result, a cross entropy loss for the classification result is calculated, and a weight update of a network constituting the classification unit 430 is performed using the stochastic gradient descent method. At this time, the classification unit 430 calculates the cross entropy loss according to the following equation.

G loss=Cross Entropy(D(G(random number, driving condition), driving condition), real) [Equation 1]

Adversarially, the generation unit 420 performs learning processing in a direction toward increasing a loss using the classification result, while the parameter weight of the artificial intelligence network by the classification unit 430 is fixed.

That is, the purpose of the generation unit 420 is to generate a realistic virtual vibration simulated signal so that the classification unit 430 cannot distinguish whether the signal is a real signal from the acceleration sensor or a virtual vibration simulated signal. Therefore, when a signal (vibration simulated signal) generated by the generation unit 420 and a real signal (engine vibration signal) are input to the classification unit 430, a weight update of a network constituting the generation unit 420 is performed using the stochastic gradient descent method in such a manner as to increase a cross entropy loss of a classification result.

At this time, the generation unit 420 calculates the cross entropy loss according to the following equation.

D loss=Cross Entropy(D(engine vibration signal, driving condition), real)+Cross Entropy(D(vibration simulated signal, driving condition, fake) [Equation 2]

While the generation unit 420 is performing learning, the weight of the classification unit 430 is fixed, and a weight update of the generation unit 420 is performed.

Accordingly, as adversarial iterative learning progresses, the classification unit 430 has improved performance in classifying signals into real signals and generated signals according to a driving condition, and the generation unit 420 generates a simulated signal similar to a real signal to the extent that the classification unit 430, which has good classification performance, misrecognizes the signal.

The generation unit 420 and the classification unit 430 perform iterative learning until the absolute loss value according to the classification result of the classification unit 430 converges to 0.5. When the final learning is completed, the signal generation unit 200 applies a learning model according to the learning result of the generation unit 420 as a generation model to output a virtual vibration signal in which an engine vibration situation of the vehicle in the driving state is reflected.

This makes it possible to mass-produce a vehicle capable of providing the ESEV function without requiring an acceleration sensor. By using the generation model subjected to final learning by the generation unit 420 in place of such an acceleration sensor for providing the ESEV function, when a current driving condition of the vehicle in the driving state and a generated random number are input, a vibration simulated signal suitable for the driving condition is output.

The output control unit 300 receives the vibration simulated signal (the vibration simulated signal generated to be suitable for the current driving condition of the vehicle in the driving state using the generation model subjected to final learning) transmitted from the signal generation unit 200, and inputs the received vibration simulated signal to a control system having the ESEV function, such that an output state of a virtual engine sound output to the vehicle in the driving state through the ADS function is controlled.

In other words, it is possible to apply the ESEV function for controlling the output of the virtual engine sound generated through the ASD function to be suitable for the current vibration situation of the engine. At this time, an output size of the virtual engine sound, which is output to be suitable for the engine vibration situation of the vehicle in the driving state, can be controlled using a virtual vibration simulated signal without a vibration signal through an acceleration sensor.

Therefore, since the ESEV function can be provided without an acceleration sensor, vehicle production costs can be reduced.

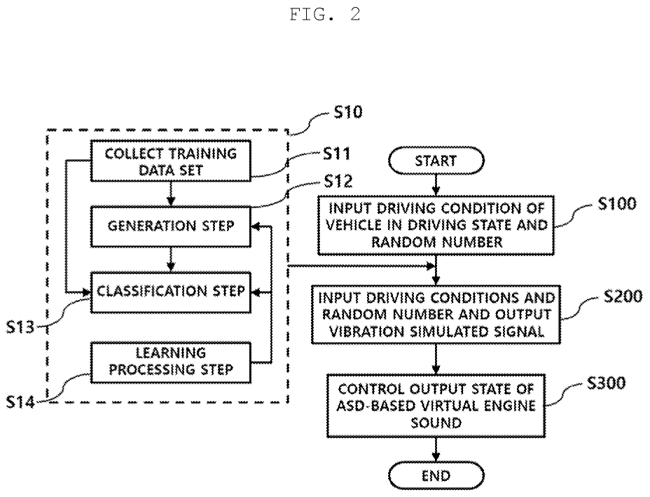

FIG. 2 is a flowchart of a virtual engine sound generating method using an engine vibration simulated signal according to an embodiment of the present invention.

As illustrated in FIG. 2, the virtual engine sound generating method using an engine vibration simulated signal according to an embodiment of the present invention includes an information input step (S100), a signal generation step (S200), and an output control step (S300). Each of the steps is preferably performed by using a virtual engine sound generating system using an engine vibration simulated signal operated by an arithmetic processing means.

The virtual engine sound generating method using an engine vibration simulated signal according to an embodiment of the present invention relates to a virtual engine sound generating method using an engine vibration simulated signal for a vehicle to which an active sound design (ASD) function and an engine sound by engine vibration (ESEV) function are applied.

Specifically, a virtual engine sound (synthesized engine sound) generated through the ASD function is output after controlling a size of the virtual engine sound to be suitable for a vibration situation of the engine based on the ESEV function.

At this point, the conventional ESEV function requires a value sensed by an acceleration sensor mounted on the engine and provided in the engine room, whereas the virtual engine sound generating system using an engine vibration simulated signal according to an embodiment of the present invention is advantageous in that the ESEV function can be provided (the acoustic effect of the virtual engine sound can be adjusted) without an acceleration sensor.

Each of the steps will be described in detail below.

In the information input step (S100), the information input unit 100 receives driving-related information from the vehicle in a driving state and a random number generated randomly through a random number generator stored in an in-vehicle control system.

Here, the vehicle in the driving state is a vehicle to which the ASD function and the ESEV function are applied, with no acceleration sensor provided in the engine room.

In addition, the driving-related information includes at least one of vehicle speed information, engine RPM information, and information currently sensed by an accelerator pedal sensor (APS).

Such driving-related information is received using an in-vehicle communication channel (CAN communication or the like).

In the signal generation step (S200), a vibration simulated signal for the engine of the vehicle in the driving state is output to the signal generation unit 200, when the driving-related information and the random number input in the information input step (S100) are input, using a stored generation model.

That is, a virtual vibration signal in which the engine vibration situation of the vehicle in the driving state is reflected is output.

To this end, the virtual engine sound generating method using an engine vibration simulated signal according to an embodiment of the present invention further includes a model generation step (S10), as illustrated in FIG. 2.

That is, the model generation step (S10) is performed to store the generation model before performing the signal generation step (S200). In the model generation step (S10), the generation model that outputs a virtual vibration simulated signal is generated by using the vehicle speed information, engine RPM information, APS sensing information, and random number input thereto, while applying conditional GAN (cGAN) algorithm.

The cGAN algorithm is a generative adversarial network in which a generator and a discriminator are conditioned using additional information while being trained. By using the cGAN algorithm, data containing desired classes can be generated, and labeled data can be used in training both the generator and the discriminator.

In the model generation step (S10), a data collection step (S11), a generation step (S12), a classification step (S13), and a learning processing step (S14) are performed.

The data collection step (S11) is a step for generating a training data set to be input to the cGAN algorithm. In the data collection step (S11), vehicle speed information, engine RPM information, and APS sensing information acquired from a data acquisition vehicle in a driving state are received. At this time, the information is received using an in-vehicle communication channel, similarly to the information input step (S100).

In addition, in the data collection step (S11), an engine vibration signal, which is a sensed signal, is received from an acceleration sensor mounted on an engine of the data acquisition vehicle.

Therefore, the data acquisition vehicle is a vehicle to which the ASD function and the ESEV function are applied, with an acceleration sensor provided in an engine room thereof.

In the data collection step (S11), the received vehicle speed information, engine RPM information, and APS sensing information of the vehicle in the driving state together with the engine vibration signal are generated as a training data set for training an artificial intelligence network, while being stored and managed in a database.

In the generation step (S12), the generation unit 420, which is a generator implemented as a convolutional neural network and having a decoder structure, generates a vibration simulated signal corresponding to the data acquisition vehicle when receiving the driving-related information in the data collection step (S11) together with a random number generated randomly through a random number generator.

That is, the generator of the cGAN algorithm receives random vectors (random noise) and labeled data, and outputs fake samples generated to match the given labels as much as possible. The purpose of the generator is to generate fake samples that match the given labels and are similar to real ones so that the discriminator cannot discriminate the fake samples.

Taking this into consideration, learning is performed in the generation step (S12) to generate signals similar to real ones so that the signals generated in the generation step (S12) are not distinguished from the real ones in the classification step (S13).

In the classification step (S13), the classification unit 430, which is a discriminator implemented as a convolutional neural network and having a classification network structure, outputs a result of classifying the vibration signal, which is a real signal, and the vibration simulated signal, which is a simulated signal, when receiving the driving-related information and the vibration signal input in the data collection step (S11) and the vibration simulated signal generated in the generation step (S12).

That is, the discriminator of the cGAN algorithm receives the data from the training data set and the fake samples generated by the generator, and outputs a probability as to which samples are real and which samples are fake. The purpose of the discriminator is to distinguish between fake sample-label pairs generated by the generator and genuine sample-label pairs from the training data set.

Taking this into consideration, learning is performed in the classification step (S13) to distinguish between real signals from the acceleration sensor and virtual simulated signals generated in the generation step (S12).

Assuming that the classification unit 430 perfectly classifies signals into real signals and simulated signals by applying cGAN algorithm, in the learning processing step (S14), an operation of the generation unit 420 for generating vibration simulated signals is learned in such a manner as to minimize a classification accuracy, and a classification operation is learned in such a manner that the classification unit 430 increases a classification accuracy against the generation unit 420 in an adversarial way.

Specifically, in the learning processing step (S14), the generation unit 420 and the classification unit 430 are processed to perform adversarial iterative learning, but it is preferable to perform control so that the generation unit 420 is trained after the classification unit 430 is trained.

To specifically describe the learning process, first of all, a vibration simulated signal is generated when actual driving-related information (driving condition) and a random number are input to the generation unit 420 (G).

The classification unit 430 (D) performs a classification operation, when the driving-related information and the engine vibration signal are input to the classification unit 430 together with the vibration simulated signal generated by the generation unit 420. By performing the classification operation, it is distinguished which signal is a real signal acquired through the acceleration sensor and which signal is a generated vibration simulated signal.

In the classification step (S13), learning processing is performed in a direction toward reducing a loss using the classification result. That is, in order to improve the classification result, a cross entropy loss for the classification result is calculated, and a weight update of a network constituting the classification unit 430 is performed using the stochastic gradient descent method.

At this time, the classification unit 430 calculates the cross entropy loss according to Equation 1 above.

Adversarially, in the generation step (S12), learning processing is performed in a direction toward increasing a loss using the classification result, while the parameter weight of the artificial intelligence network by the classification unit 430 is fixed.

That is, the purpose of the generation unit 420 is to generate a realistic virtual vibration simulated signal so that the classification unit 430 cannot distinguish whether the signal is a real signal from the acceleration sensor or a virtual vibration simulated signal. Therefore, when a signal (vibration simulated signal) generated by the generation unit 420 and a real signal (engine vibration signal) are input to the classification unit 430, a weight update of a network constituting the generation unit 420 is performed using the stochastic gradient descent method in such a manner as to increase a cross entropy loss of a classification result.

At this time, the generation unit 420 calculates the cross entropy loss according to Equation 2 above.

While learning is being performed in the generation step (S12), the weight of the classification unit 430 is fixed, and a weight update of the generation unit 420 is performed.

Accordingly, as adversarial iterative learning progresses, the classification unit 430 has improved performance in classifying signals into real signals and generated signals according to a driving condition, and the generation unit 420 generates a simulated signal similar to a real signal to the extent that the classification unit 430, which has good classification performance, misrecognizes the signal.

The generation unit 420 and the classification unit 430 perform iterative learning until the absolute loss value according to the classification result in the classification step (S13) converges to 0.5. When the final learning is completed, a learning model according to the result of the final learning in the generation step (S12) is applied as a generation model in the signal generation step (S200) to output a virtual vibration signal in which an engine vibration situation of the vehicle in the driving state is reflected.

This makes it possible to mass-produce a vehicle capable of providing the ESEV function without requiring an acceleration sensor. By using the generation model subjected to final learning in the generation step (S12) in place of such an acceleration sensor for providing the ESEV function, when a current driving condition of the vehicle in the driving state and a generated random number are input, a vibration simulated signal suitable for the driving condition is output.

In the output control step (S300), the output control unit 300 inputs the vibration simulated signal (the vibration simulated signal generated to be suitable for the current driving condition of the vehicle in the driving state using the generation model subjected to final learning) generated in the signal generation step (S200) to a control system having the ESEV function, such that an output state of a virtual engine sound output to the vehicle in the driving state through the ADS function is controlled.

In other words, it is possible to apply the ESEV function for controlling the output of the virtual engine sound generated through the ASD function to be suitable for the current vibration situation of the engine. At this time, an output size of the virtual engine sound, which is output to be suitable for the engine vibration situation of the vehicle in the driving state, can be controlled using a virtual vibration simulated signal without a vibration signal through an acceleration sensor.

Therefore, since the ESEV function can be provided without an acceleration sensor, vehicle production costs can be reduced.

The present invention described above can be implemented as a computer-readable code on a medium where a program is recorded. The computer-readable media include all types of recording devices in which data that can be read by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like, and the computer-readable medium may also be implemented in the form of a carrier wave (for example, transmission over the Internet). In addition, the computer may include a virtual engine sound generating system using an engine vibration simulated signal according to the present invention.

Although the preferred embodiments of the present invention have been described above, the embodiments disclosed herein are not intended to limit the technical idea of the present invention, but are provided to explain the technical idea of the present invention. Therefore, the technical idea of the present invention includes not only each of the embodiments disclosed herein but also a combination of the embodiments disclosed here, and furthermore, the scope of the technical idea of the present invention is not limited by these embodiments. In addition, those skilled in the art to which the present invention pertains may make numerous changes and modifications to the present invention without departing from the spirit and scope of the appended claims, and all of such appropriate changes and modifications shall be regarded as falling within the scope of the present invention as equivalents.

What is claimed is:

1. A virtual engine sound generating system using an engine vibration simulated signal for a vehicle to which an active sound design (ASD) function and an engine sound by engine vibration (ESEV) function are applied, the virtual engine sound generating system comprising:
an information input unit configured to receive driving-related information from the vehicle in a driving state and a random number generated randomly through a random number generator and to provide the driving-related information from the vehicle in the driving state and the random number to a stored generation model;
a signal generation unit configured to receive a vibration simulated signal for an engine of the vehicle in the driving state from the stored generation model and to provide the vibration simulated signal to a control system having the ESEV; and
an output control unit configured to control an output state of a virtual engine sound output to the vehicle in the driving state through the ASD function, when the signal generation unit inputs the vibration simulated signal to a control system having the ESEV function.

2. The virtual engine sound generating system of claim 1, wherein the driving-related information input to the information input unit includes at least one of vehicle speed information, engine RPM information, and accelerator pedal sensor (APS) sensing information of the vehicle in the driving state.

3. The virtual engine sound generating system of claim 1, wherein the output control unit controls an output size of the virtual engine sound output based on the vibration simulated signal.

4. The virtual engine sound generating system of claim 1, further comprising a model generation unit configured to generate the generation model that outputs the virtual vibration simulated signal using vehicle speed information, engine RPM information, APS sensing information, and the random number input thereto, as inputs while applying conditional GAN (cGAN) algorithm.

5. The virtual engine sound generating system of claim 4, wherein the model generation unit includes:
a data collection unit configured to receive driving-related information in a driving state from a data acquisition vehicle, to which the ADS function and the ESEV function are applied with an acceleration sensor mounted to an engine thereof, and a vibration signal from the acceleration sensor to be collected in a database;
a generation unit implemented as a convolutional neural network and having a decoder structure, the generation unit being configured to generate a vibration simulated signal corresponding to the data acquisition vehicle when receiving the driving-related information from the data collection unit together with the random number generated randomly through the random number generator;
a classification unit implemented as a convolutional neural network and having a classification network structure, the classification unit configured to output a result of classifying the vibration signal, which is a real signal, and the vibration simulated signal, which is a simulated signal, when receiving the driving-related information and the vibration signal from the data collection unit and the vibration simulated signal from the generation unit; and
a learning processing unit configured to learn an operation of the generation unit for generating vibration simulated signals in such a manner as to minimize a classification accuracy, and to learn a classification operation in such a manner that the classification unit increases a classification accuracy against the generation unit in an adversarial way by applying cGAN algorithm.

6. The virtual engine sound generating system of claim 5, wherein the learning processing unit controls the generation unit and the classification unit to perform adversarial iterative learning in such a manner that the generation unit is trained after the classification unit is trained.

7. The virtual engine sound generating system of claim 6, wherein the signal generation unit applies a learning model according to a learning result of the generation unit as the generation model.

8. A virtual engine sound generating method using an engine vibration simulated signal using a virtual engine sound generating system using an engine vibration simulated signal for a vehicle to which an active sound design (ASD) function and an engine sound by engine vibration (ESEV) function are applied, the virtual engine sound generating method comprising the following steps, each being performed by an arithmetic processor, the method comprising:
performing an information input step in which driving-related information from the vehicle in a driving state and a random number generated randomly through a random number generator are input to a stored generation model;
performing a signal generation step in which a vibration simulated signal for an engine of the vehicle in the driving state is output from the generation model in response to receiving the driving-related information and the random number; and
performing an output control step in which an output state of a virtual engine sound output to the vehicle in the driving state through the ADS function is controlled, when the vibration simulated signal generated in the signal generation step is input to a control system having the ESEV function.

9. The virtual engine sound generating method of claim 8, wherein, in the information input step, the driving-related information includes at least one of vehicle speed information, engine RPM information, and accelerator pedal sensor (APS) sensing information of the vehicle in the driving state.

10. The virtual engine sound generating method of claim 8, wherein, in the output control step, an output size of the virtual engine sound output to the vehicle in the driving state through the ADS function is controlled based on the vibration simulated signal.

11. The virtual engine sound generating method of claim 8, further comprising:
performing a model generation step in which the generation model is generated using vehicle speed information, engine RPM information, APS sensing information, and the random number input thereto, while applying conditional GAN (cGAN) algorithm and stored before the signal generation step is performed.

12. The virtual engine sound generating method of claim 11, wherein the model generation step includes:
performing a data collection step in which driving-related information in a driving state from a data acquisition vehicle, to which the ADS function and the ESEV function are applied with an acceleration sensor mounted an engine thereof, and a vibration signal from the acceleration sensor are input;
performing a generation step in which a generation unit implemented as a convolutional neural network and having a decoder structure generates a vibration simulated signal corresponding to the data acquisition vehicle when receiving the driving-related information input in the data collection step together with a random number generated randomly through a random number generator;
performing a classification step in which a classification unit implemented as a convolutional neural network and having a classification network structure outputs a result of classifying the vibration signal, which is a real signal, and the vibration simulated signal, which is a simulated signal, when receiving the driving-related information and the vibration signal input in the data collection step and the vibration simulated signal generated in the generation step; and
performing a learning processing step in which an operation of the generation unit for generating vibration simulated signals is learned in such a manner as to minimize a classification accuracy, and a classification operation is learned in such a manner that the classification unit increases a classification accuracy against the generation unit in an adversarial way, assuming that the classification unit perfectly classifies signals into real signals and simulated signals by applying cGAN, and
in the learning processing step, controlling the generation unit and the classification unit to perform adversarial iterative learning in such a manner that the generation unit is trained after the classification unit is trained.

13. The virtual engine sound generating method of claim 12, wherein in the signal generation step, a learning model according to a learning result of the generation unit is applied as the generation model.
